(19) United States
(12) Patent Application Publication
(10) Pub. No.: US 2015/0198289 A1
(43) Pub. Date: Jul. 16, 2015

(54) LIGHT TUBE

(71) Applicant: Chen-Wei HSU, Tainan (TW)

(72) Inventor: Chen-Wei HSU, Tainan (TW)

(21) Appl. No.: 14/155,387

(22) Filed: Jan. 15, 2014

(51) Int. Cl. F21K 99/00

(52) U.S. Cl. CPC F21K 9/175; F21Y 2103/003

(57) ABSTRACT

A light tube includes a silicone tube and two Light Emitting Diode tubes. The silicone tube is made by silicone which allows light beams to pass therethrough evenly. The silicone tube has a flat bottom and a curved top. A passage and at least one axial hole are defined axially through the silicone tube. The Light Emitting Diode tubes each have multiple Light Emitting Diodes connected thereto. Wires are connected to the Light Emitting Diode tubes. The Light Emitting Diode tubes are inserted in the passage. The light tube is fixed to an object and the light beams from the Light Emitting Diodes evenly delivered from the light tube to provide warning signals or decoration feature.

### BACKGROUND OF THE INVENTION

1. Fields of the Invention

The present invention relates to a light tube, and more particularly, to a light tube which evenly release light.

2. Descriptions of Related Art

The conventional light tube 1 is used to provide warning signal and is disclosed in FIG. 1. Most of the conventional light tubes 1 are made by glass or other hard material which allows light beams to pass. The glass or hard material is bent to a desired shape. A light emitting member 10 is connected to each of the two ends of the light tube 1. The light emitting member 10 can be a light bulb or a Light Emitting Diode. The light beams emitting from the light emitting members 10 are projected to the light tube 1 to generate visible light so as to be used as warning signals or decoration light. However, the lighting members 10 are only located on the two ends of the light tube 1 so that the middle section of the light tube is dim than the two ends of the light tube 1. This reduces the warning feature when the light tube 1 is used as a warning light.

The present invention intends to provide a light tube that can be bent to be desired shape and fixed to an object so as to be used as a warning signal or decoration light. The light tube of the present invention improves the shortcomings mentioned above.

### SUMMARY OF THE INVENTION

The present invention relates to a light tube and comprises a silicone tube and two Light Emitting Diode tubes. The silicone tube is made by silicone which allows light beams to pass therethrough evenly. The silicone tube has a flat bottom and a curved top. A passage and at least one axial hole are defined axially through the silicone tube. The Light Emitting Diode tubes each have multiple Light Emitting Diodes connected thereto. Wires are connected to the Light Emitting Diode tubes. The Light Emitting Diode tubes are inserted in the passage.

Preferably, the curved top of the silicone tube has at least one first groove defined axially therein to let the light beams emitting from the light tube be more evenly.

Preferably, multiple ridges extend from two lateral sides of the silicone tube so as to be connected to an object.

Preferably, the passage has an inside located close to the curved top and the inside has multiple second grooves defined therein so as to refract the light beams.

The light tube of the present invention can be bent to desired shapes and fixed to different objects so as to provide warning signals or decoration feature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional light tube;

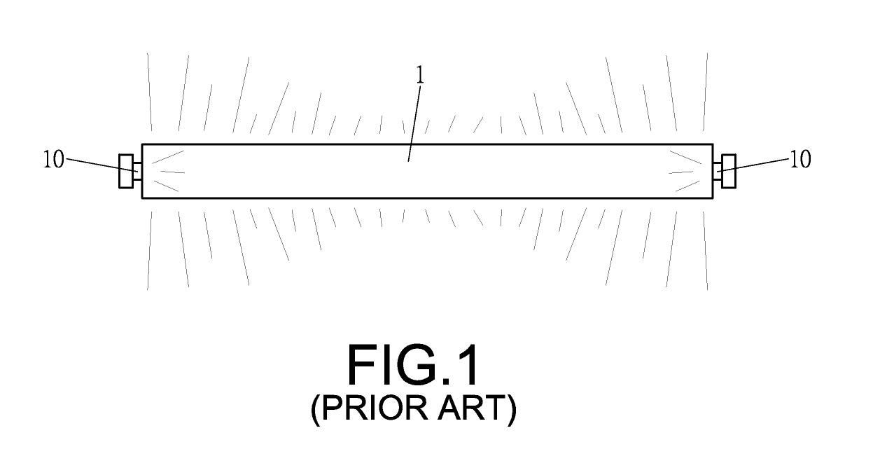

FIG. 2 is an exploded view of the light tube of the present invention;

FIG. 3 is a perspective view to show the light tube of the present invention;

FIG. 4 is a cross sectional view of the light tube of the present invention;

FIG. 5 shows that the light tube of the present invention is fixed to a backpack, and

FIG. 6 shows that the light tube of the present invention is fixed to a triangular traffic warning sign.

### DETAILED DESCRIPTION OF THE PREFERRED EMBODIMENT

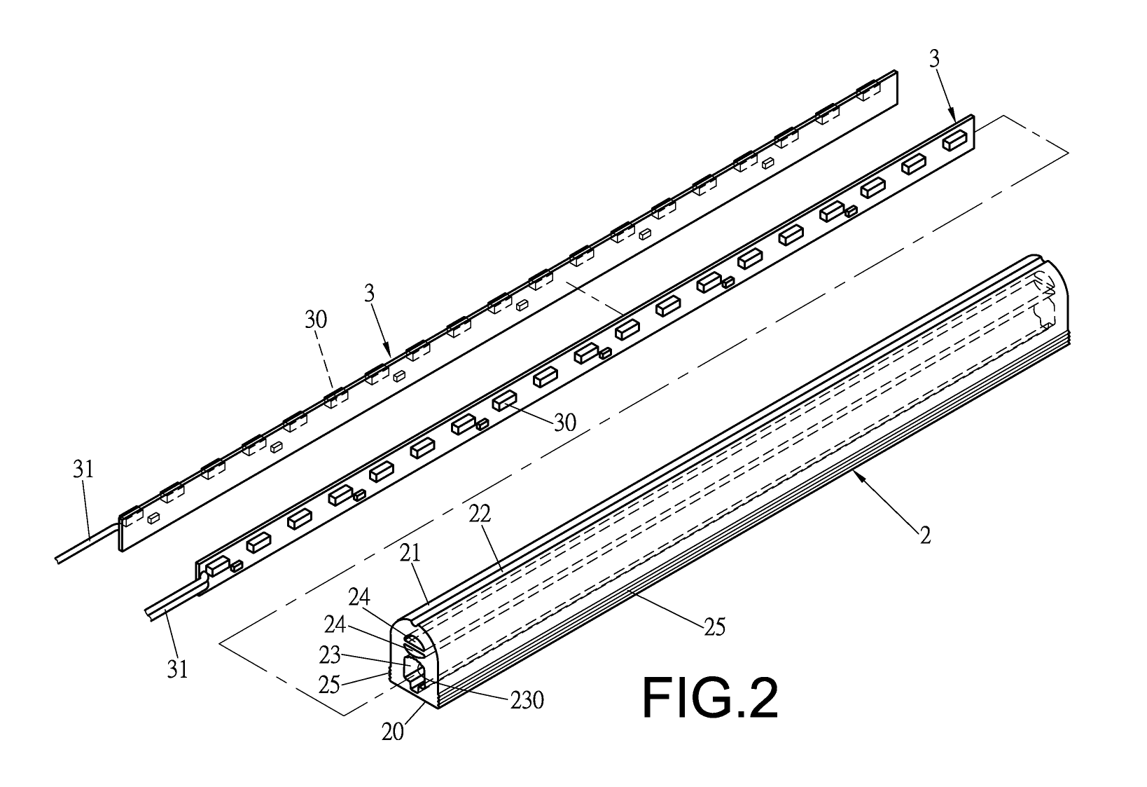

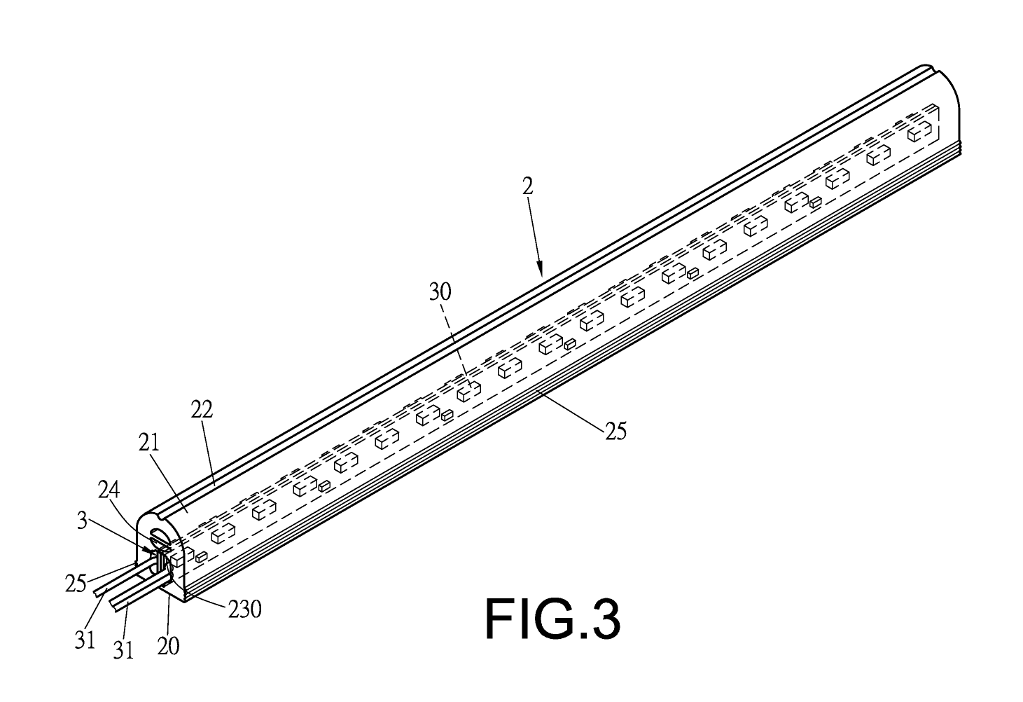

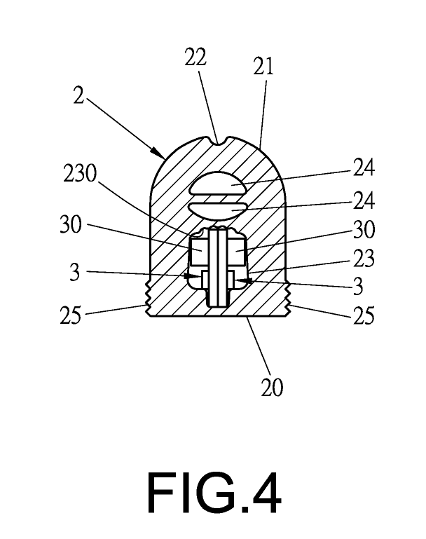

Referring to FIGS. 2 to 4, the light tube 1 of the present invention comprises a silicone tube 2 and two Light Emitting Diode tubes 3. The silicone tube 2 is made by silicone which allows light beams to pass therethrough evenly. The silicone tube 2 has a flat bottom 20 and a curved top 21. The curved top 21 of the silicone tube 2 has at least one first groove 22 defined axially therein. A passage 23 and at least one axial hole 24 are defined axially through the silicone tube 2. The passage 23 has an inside located close to the curved top 21 and the inside has multiple second grooves 230 defined therein. Multiple ridges 25 extend from two lateral sides of the silicone tube 2. The two Light Emitting Diode tubes 3 each have multiple Light Emitting Diodes 30 connected thereto. Wires 31 are connected to the at least one Light Emitting Diode tube 3. The two Light Emitting Diode tubes 3 are inserted to the passage 23 in pair. The Light Emitting Diodes 30 on each of the two Light Emitting Diode tubes 3 are grouped every three Light Emitting Diodes 30.

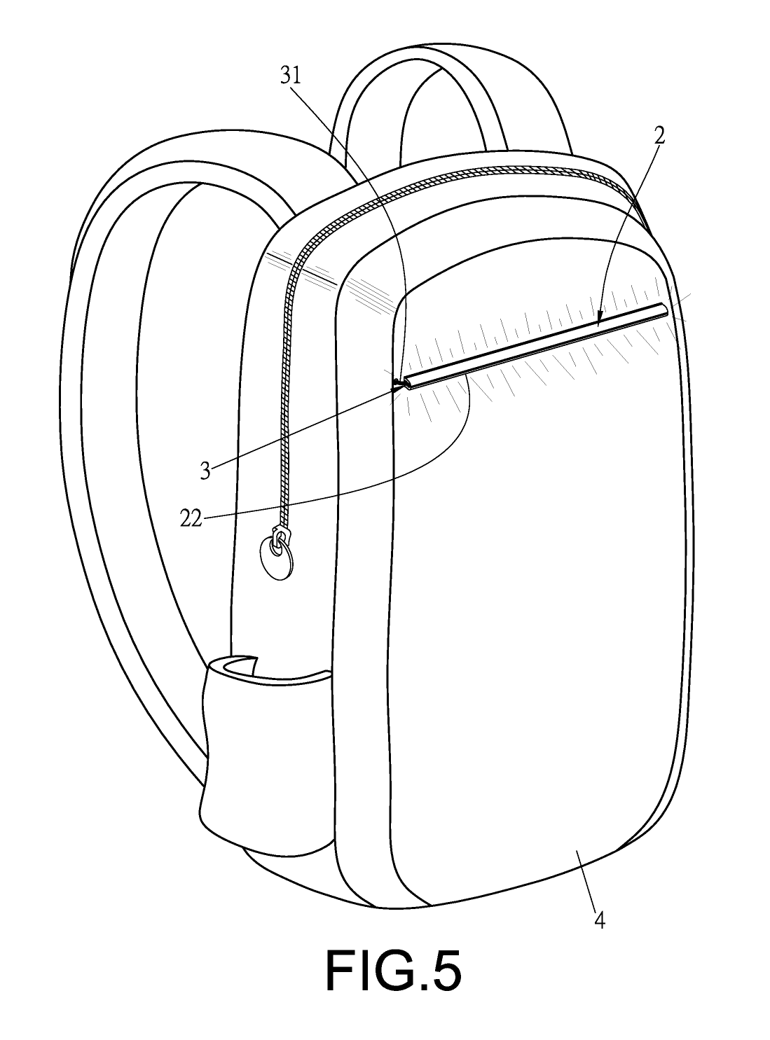

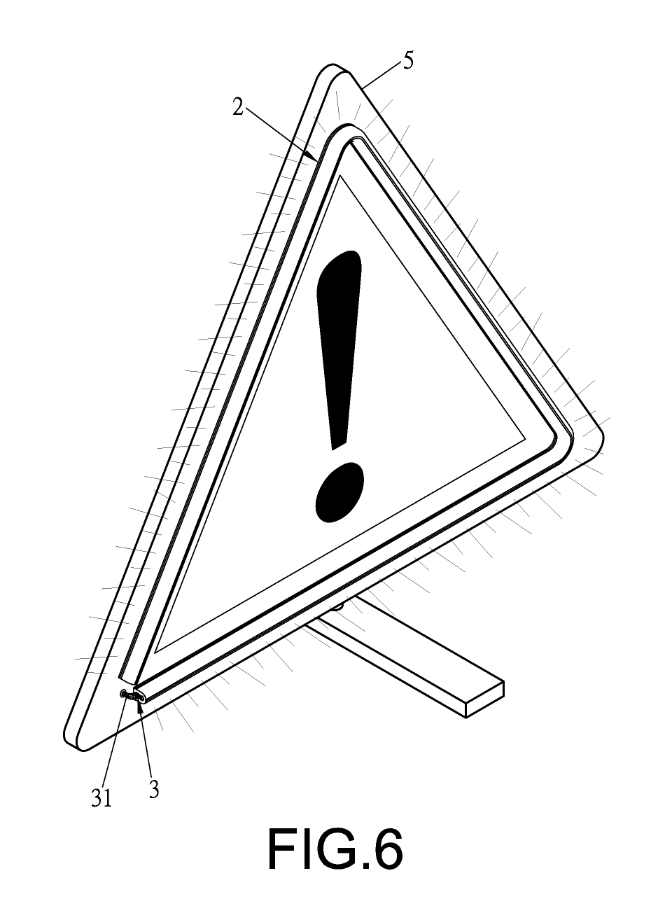

As shown in FIGS. 5 and 6, when in use, glue is applied to the flat bottom 20 of the silicone tube 2 so as to be fixed on an object firmly. The object can be a backpack 4, a triangular traffic warning sign 5, a commercial advertisement board, the lateral side of a vehicle or a door handle. The Light Emitting Diodes 30 on each of the two Light Emitting Diode tubes 3 are powered and generate light beams which pass through the silicone tube 2. Because the two Light Emitting Diode tubes 3 are installed in pair so that the light beams evenly pass through the silicone tube 2. The Light Emitting Diodes 30 are grouped every three Light Emitting Diodes 30 so that even when one of the three Light Emitting Diodes 30 fails to function to cause the three Light Emitting Diodes 30 fail to light up, the lighting feature of the light tube 1 is still satisfied. The first groove 22 in the curved top 21 of the silicone tube 2 refracts the light beams to be even on the surface of the light tube 1. Furthermore, the second grooves 230 in the passage 23 evenly refract the light beams from the Light Emitting Diodes 30 to provide even lighting feature of the light tube 1. The silicone tube 2 is flexible and can be bent to desired shapes. The passage 24 of the silicone tube 2 provides sufficient room when the silicone tube 2 is bent so that the silicone tube 2 can be easily and conveniently bent. The ridges 25 on the lateral sides of the silicone tube 2 are used to fix the light tube 1 to the objects as mentioned above. The Light Emitting Diodes 30 may designed to have different colors and the light tube 1 is bent to desired shapes so as to provide attractive and decoration features.

While we have shown and described the embodiment in accordance with the present invention, it should be clear to those skilled in the art that further embodiments may be made without departing from the scope of the present invention.

What is claimed is:

1. A light tube comprising:
a silicone tube and at least one Light Emitting Diode tube, the silicone tube being made by silicone which allows light beams to pass therethrough evenly, the silicone tube having a flat bottom and a curved top, a passage and at least one axial hole defined axially through the silicone tube, the at least one Light Emitting Diode tube having multiple Light Emitting Diodes connected thereto, wires connected to the at least one Light Emitting Diode tube, the at least one Light Emitting Diode tube being inserted in the passage.

2. The light tube as claimed in claim 1, wherein the curved top of the silicone tube has at least one first groove defined axially therein.

3. The light tube as claimed in claim 1, wherein multiple ridges extending from two lateral sides of the silicone tube.

4. The light tube as claimed in claim 1, wherein the passage has an inside located close to the curved top and the inside has multiple second grooves defined therein.
